(19) United States
(12) Patent Application Publication
(10) Pub. No.: US 2008/0056789 A1
(43) Pub. Date: Mar. 6, 2008

(54) Scanner page alignment tools

(75) Inventor: Lee Coy Moore, Penfield, NY (US)

Correspondence Address: JAMES J. RALABATE, 5792 MAIN STREET, WILLIAMSVILLE, NY, 14221, US

(73) Assignee: Xerox Corporation

(21) Appl. No.: 11/514,276

(22) Filed: Sep. 1, 2006

(51) Int. Cl. G03G 15/00

(52) U.S. Cl. 399/379

(57) ABSTRACT

This is a system to provide real time ways of aligning a paper original with a skewed image so that a right imaged reproduction is produced on subsequent copies.

This invention relates to electrostatic marking systems and, more specifically, to scanner components and techniques of these systems.

### BACKGROUND

In electrostatographic process, a system is used whereby a uniform electrostatic charge is placed upon a reusable photoconductive surface. The charged photoconductive surface is then exposed to a light image of a scanned original document to selectively dissipate the charge to form a latent electrostatic image of this original on the photoreceptor. The latent image is developed by depositing finely divided marking and charged particles (toner) upon the photoreceptor surface. The charged toner is electrostatically attached to the latent electrostatic image areas to create a visible replica of the original. The toned developed image is then transferred from the photoconductor surface to a final image support material, such as paper, and the toner image is fixed thereto by heat and pressure to form a permanent copy corresponding to the original.

In Xerographic systems of this type, a photoreceptor surface is generally arranged to move in an endless path through the various processing stations of the Xerographic process. The photoconductive or photoreceptor surface is generally reusable whereby the toner image is transferred to the final support material, and the surface of the photoreceptor is prepared to be used once again for another reproduction of an original scanned document.

Several methods are known for applying an electrostatic charge to the photosensitive member such as the use of electron-emitting pins, an electron-emitting grid, single corona-charging structures and single or multiple dicorotron wire assemblies. In recent development of high speed Xerographic reproduction machines where copiers can produce at a rate of or in excess of three thousand copies per hour, the need for reliable scanning techniques and properly aligned final copies are required.

Usually, in electrostatographic or electrostatic copy processes, as those above noted, an original document is placed upon a platen glass and scanned whereby the scanned image is transferred to the photoconductor surface. It is difficult to align paper documents on a multi-function scanner platen because the paper is placed face down and thus not directly viewable by a user. Sometimes multi-generation originals will have badly skewed printed images so that aligning the paper to the edges of the scanner will not have the desired result. In such cases, multiple copies must be made until the image on the paper has the correct alignment that is squared with the paper.

### SUMMARY

The various embodiments of the present invention provide a system, process and apparatus whereby proper alignment of an image on an original document is effectively achieved.

Some original paper documents have images on them that are not quite square with the paper. Some scanners do not scan all the way to the edge of the paper (not full bleed). This leads to causes where the user wants to have the best image but (face down) scanning technologies that are used in multifunction devices lead to multiple scans and prints being made.

It would be desirable to have a real-time way of aligning the paper so that the “right” image is produced.

There are several approaches in the present invention that one could take based on cost and ease of use. They are flood lamps from above or below to illuminate the paper enough to show a back lit image. This would provide a rough guide for single sheets of paper. Alignment marks could be painted with rotating laser beams from below and/or above. This would provide a grid for aligning to. Also, a low cost camera could be put in the scanner well and the image from it would be displayed as a real time video image on the multi-function's user interface.

There is provided in the present embodiments ways for making a scanner easier to use when alignment becomes critical. This could be a useful productivity tool and a product differentiator.

This invention, as above noted, proposes three methods to align an image that is skewed with respect to the edge of the substrate so the resulting scan is aligned with the edges of the image. 1) An internal floodlight that illuminates for the image alignment phase would let the operator view the material to be scanned through the back of the substrate. 2) Alignment marks could be projected onto the substrate with a laser or other device. 3) A simple video camera could be added to provide a real time preview image so the original can be rotated into position.

### BRIEF DESCRIPTION OF THE DRAWINGS

FIG. 1 is an illustration of an imaged substrate where the text of the image needs to be better aligned.

FIG. 2 illustrates a side view of an embodiment where a floodlight or lights illuminates the imaged paper or substrate from underneath.

FIG. 3 illustrates a top view of an embodiment where alignment marks are projected onto the back of the substrate.

FIG. 4 illustrates a side view of an embodiment where a simple video camera is used to provide real time preview image.

### DETAILED DISCUSSION OF DRAWINGS AND PREFERRED EMBODIMENTS

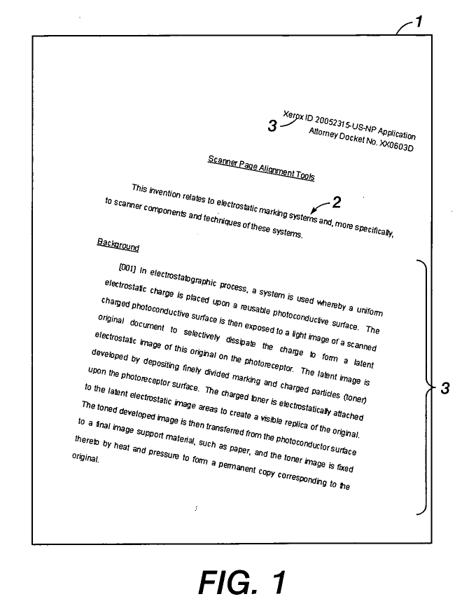

In FIG. 1 an imaged paper page 1 has an image or marking 2 that is badly skewed (as shown at 3) and not squared with the paper 1. As new generations of copies of page 1 are made, progressively misaligned images 2 frequently occur, more pronounced as new generations are made from badly skewed originals. The embodiments herein described provide ways of making proper alignment of skewed image 3.

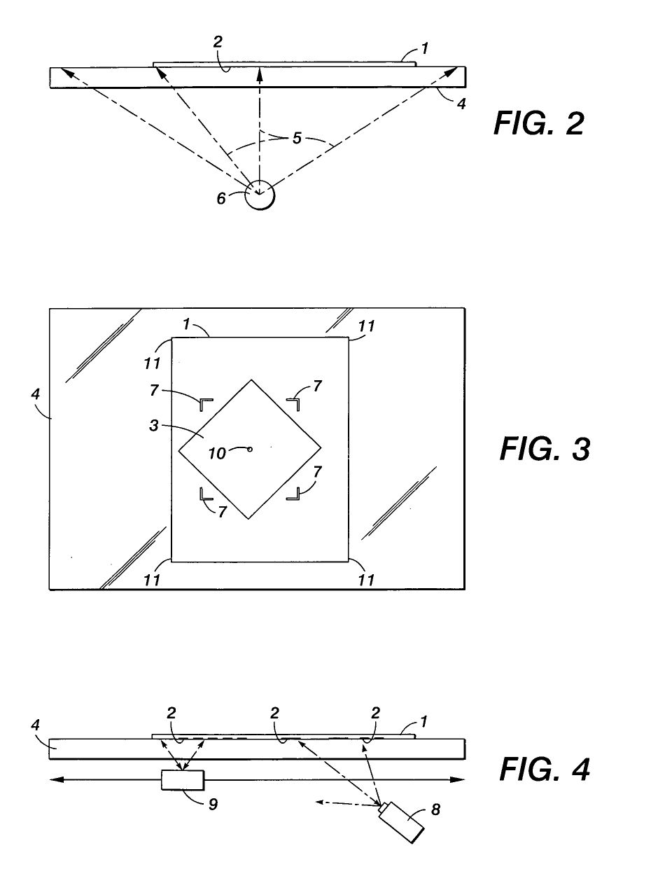

One embodiment for providing a proper alignment is shown in side view of FIG. 2 where a floodlight or lights 6 (or other suitable lighting means) is used with light rays 5 to illuminate the platen glass 4 and original paper 1 from either or both above or below enough to show a backlit image. The paper 1 is placed image face down on platen 4. This backlit image 2 or skewed image 3 will provide a rough guide for single sheets of paper 1 having an image 2 out of alignment. The paper 1 merely needs to be adjusted on platen 4 until a properly squared image 2 is obtained to be transferred to the next copy made. The floodlight 6 may be positioned in a well below the platen glass 4 or in any other suitable location.

In FIG. 3, a top view of a platen 4 is shown as it supports an original paper 1. The misaligned original of FIG. 1 merely needs to be rotated or moved so that skewed image 3 (not paper) is now squared within markings 7 so that copies of images 2 made from this original 1 will be squared with the paper 1. The alignment marks 7 can be painted with rotating lasers from below or above platen 4. These alignment marks 7 can be projected onto the paper substrate 1 or onto the platen 4. Again, paper 1 is placed upon platen 4 with the imaged surface 2 of paper 1 face down. These marks 4 provide a grid for aligning the skewed image 3. Also, the misaligned copy of FIG. 1 in another embodiment is fit within squared markings 7 so that each corner of the copy fits within the area outlined by the markings 7. The copy within markings 7 is then rotated along axis 10 until the text of the copy is even vertically and horizontally (using platen corners 11 as a gauge). The misaligned copy is now perfectly squared and can be copied in proper alignment. Paper 1 is not drawn to scale for clarity of description of this embodiment.

In FIG. 4, a side view of an embodiment is illustrated where a camera 8 (such as a low cost camera) is placed above the paper 1 or in the scanner means 9. The simple video camera 8 can be added to provide a real time preview image 2 so the original 1 can be rotated in position. The camera 8 could be put in the scanner 9 well and the image from it would be displayed in real time video on the multi-function's user interface.

In summary, the present embodiments provide an electrostatic copy system comprising an image exposure station. This image exposure station comprises in an operative arrangement a platen glass together with at least one member selected from the group consisting of flood lamp(s), a camera(s) and paper or substrate alignment marks. In this system, the flood lamp(s) is positioned above or below said platen glass and is enabled to illuminate a paper placed face down upon said platen glass. Also, the alignment marks are projected upon the platen glass to provide thereby a grid for aligning the paper. Further, a camera is positioned in a scanner well; this camera is enabled to project an image displayed in a real time video image on a multifunction user interface. When the floodlight is used, the floodlight is enabled to allow an operator to view an image through a clear platen and on the paper through the back of the paper or substrate. The present electrostatic copy system as noted comprises an image exposure station adapted to process an imaged substrate or paper. This image exposure station comprises in an operative arrangement a platen glass unit together with at least one paper alignment member selected from the group consisting of a flood lamp(s), a video camera(s), and substrate alignment marks. The platen glass unit is adapted to support and scan the imaged paper. The substrate alignment members are adapted to align the imaged paper to provide an image thereon that is squared with the paper. Also, these alignment members are enabled to permit the scanner operator to know where which areas of the platen glass are not scanned so that a full and complete image can be reproduced. The flood lamp(s) are positioned above or below the platen glass and is enabled to illuminate the paper that is placed image face down upon the transparent or clear platen glass. The alignment marks are laser projected upon the platen glass to provide thereby a grid for aligning the imaged paper.

The preferred and optimally preferred embodiments of the present invention have been described herein and shown in the accompanying drawings to illustrate the underlying principles of the invention, but it is to be understood that numerous modifications and ramifications may be made without departing from the spirit and scope of this invention.

What is claimed is:

1. An electrostatic copy system comprising an image exposure station, said image exposure station comprising in an operative arrangement a platen glass together with at least one member selected from the group consisting of flood lamp(s), a camera(s) and paper or substrate alignment marks.

2. The system of claim 1 wherein said flood lamp(s) is positioned above or below said platen glass and is enabled to illuminate a paper placed face down upon said platen glass.

3. The system of claim 1 wherein said alignment marks are projected above or below upon said platen glass to provide thereby a grid for aligning said paper.

4. The system of claim 1 wherein a camera is positioned in a scanner well, said camera enabled to project an image displayed in a real time video image on a multi-function user interface.

5. The system of claim 1 wherein said floodlight is enabled to allow an operator to view an image on said paper through the back of said paper or substrate.

6. The system of claim 1 wherein said alignment marks are enabled to be projected onto said substrate.

7. The system of claim 1 wherein said camera is enabled to project an image of said marked substrate to thereby allow a user to realign said image, if required.

8. An electrostatic copy system comprising an image exposure station adapted to process an imaged substrate or paper, said image exposure station comprising in an operative arrangement a platen glass unit together with at least one substrate alignment member selected from the group consisting of a flood lamp(s), a camera(s), and substrate alignment marks, said platen glass unit adapted to support and scan said imaged substrate, said substrate alignment members adapted to align said imaged substrate to provide an image thereon squared with said paper.

9. The system of claim 8 wherein said flood lamp(s) is positioned above or below said platen glass and is enabled to illuminate a paper placed face down upon said platen glass.

10. The system of claim 8 wherein said alignment marks are projected upon said platen glass to provide thereby a grid for aligning said paper.

11. The system of claim 8 wherein a camera is positioned in a scanner well, said camera enabled to project an image displayed in a real time video image on a multi-function user interface.

12. The system of claim 8 wherein said floodlight is enabled to allow an operator to view an image on said paper through the back of said paper or substrate.

13. The system of claim 8 wherein said alignment marks are enabled to be projected onto said substrate.

14. The system of claim 8 wherein said camera is enabled to project an image of said marked substrate to thereby allow a user to realign said image, if required.

15. An electrostatic copy system comprising an image exposure station adapted to process an imaged substrate or paper, said image exposure station comprising in an operative arrangement a platen glass unit together with at least one paper alignment member selected from the group consisting of a flood lamp(s), a video camera(s), and substrate alignment marks, said platen glass unit adapted to support and scan said imaged paper, said substrate alignment members adapted to align said imaged paper to provide an image thereon that is squared with said paper, said flood lamp(s) positioned above and/or below said platen glass and is enabled to illuminate said paper that is placed image face down upon said platen glass and wherein said alignment marks are laser projected upon said platen glass to provide thereby a grid for aligning said imaged paper.

16. The system of claim 15 wherein a camera is positioned in a scanner well, said camera enabled to project an image displayed in a real time video image on a multi-function user interface.

17. The system of claim 15 wherein said floodlight is enabled to allow an operator to view an image on said paper through the back of said paper or substrate.

18. The system of claim 15 wherein said alignment marks are enabled to be projected onto said substrate.

19. The system of claim 15 wherein said camera is enabled to project an image of said substrate to thereby allow a user to realign said image, if required.
